(19) United States
(12) Patent Application Publication
(10) Pub. No.: US 2008/0246698 A1
(43) Pub. Date: Oct. 9, 2008

(54) Organic light emitting display device and driving method thereof

(76) Inventor: Ki-myeong Eom, Suwon-si (KR)

Correspondence Address: ROBERT E. BUSHNELL, 1522 K STREET NW, SUITE 300, WASHINGTON, DC, 20005-1202, US

(21) Appl. No.: 12/073,456

(22) Filed: Mar. 5, 2008

(30) Foreign Application Priority Data
Apr. 6, 2007 (KR) 10-2007-0034098

(51) Int. Cl. G09G 3/30

(52) U.S. Cl. 345/76

(57) ABSTRACT

An organic light emitting display device and a driving method thereof, capable of preventing malfunction due to an overload of a scan driver and an abnormal lighting phenomenon of pixels.

A driving method of an organic light emitting display device according to the present invention includes the steps of: supplying scan signals generated by scan driving power supplies and scan driving control signals to a pixel unit; supplying data signals generated by data driving power supplies, data, and data driving control signals to the pixel unit; and light emitting pixels provided in the pixel unit by means of pixel power supplies supplied to the pixel unit after the scan signals and the data signals are generated, the scan signals and data signals. The organic light emitting display device has a timing controller supplying output enable signals to the scan driver one or more frames after the time point of starting supplying start pulses and clock signals to the scan driver and a power supplier supplying pixel power supplies after the generation of scan signals and data signals starts.

### CLAIM OF PRIORITY

This application makes reference to, incorporates the same herein, and claims all benefits accruing under 35 U.S.C. §119 from an application for ORGANIC LIGHT EMITTING DISPLAY AND DRIVING METHOD THEREOF earlier filed in the Korean Intellectual Property Office on 6^{th} of April 2007 and there duly assigned Serial No. 10-2007-0034098.

### BACKGROUND OF THE INVENTION

1. Field of the Invention

The present invention relates to an organic light emitting display device and a driving method thereof, and more particularly to an organic light emitting display device and a driving method thereof capable of preventing malfunction due to an overload of a scan driver and an abnormal lighting phenomenon of pixels.

2. Description of the Related Art

Recently, various flat panel display devices with lighter weight and less volume, because heavier weight and more volume are considered as disadvantages of a cathode ray tube. Flat panel display devices have many kinds, including a liquid crystal display (LCD), a field emission display (FED), a plasma display panel (PDP) and an organic light emitting display (OLED), and some other kind of displays.

Among others, an organic light emitting display displays images by using an organic light emitting diode generating lights by re-coupling of electrons and holes. Because the organic light emitting display is driven at low power consumption and has a rapid response speed, this kind of display has been spotlighted as a promising next generation display.

An organic light emitting display device includes a scan driver generating scan signals, a data driver generating data signals, and a pixel unit displaying images corresponding to the generated scan signals and the generated data signals.

The scan driver generates scan signals depending on scan driving control signals such as start pulses, clock signals, output enable signals and other related external signals supplied from the exterior of the scan driver in a predetermined sequence.

More specifically, the scan driver includes a shift register unit generating sampling pulses while sequentially shifting the start pulses corresponding to the clock signals, and a signal generator generating scan signals and light emitting control signals corresponding to the start pulses, the output enable signals and the sampling pulses.

In a general organic light emitting display device, the supply of the scan driving control signals such as the start pulses, the clock signals, the output enable signals and other related external signals, however, simultaneously start after a first and a second scan driving power supplies are applied.

In this case, the output of the shift register unit has a predetermined high level state or a predetermined low level state before the first and second scan driving power supplies are applied and the scan driving control signals are supplied has value of high level or low level. If the scan driving control signals are supplied in such circumstance, the sampling pulses are generated by the shift register in a sequence in accordance with the clock signals based on the start pulses.

In recent efforts in the art, the output enable signals are supplied simultaneously with the start pulses. When the output of the shift register unit is in a high level state, all logic circuits in a signal generator electrically connected to respective scan lines and light emitting control lines may simultaneously operate so that the scan driver is consequently overloaded.

Therefore, the prior art may cause a malfunction of the scan driver, for example, the voltage level of the signals generated from the scan driver may not reach the threshold capable of driving a pixel.

The pixel unit includes scan lines and light emitting control lines supplied with the scan signals and light emitting control signals, and a plurality of pixels connected to data lines supplied with the data signals.

In a general organic light emitting display device, however, a pixel circuit for controlling organic light emitting diodes within each pixel is employed and this pixel circuit is supplied with a first and a second pixel power supplies to maintain the pixel in a standby state. In the standby state, if the scan signals, the data signals and the light emitting control signals are supplied to a pixel, the pixel may emit lights with a brightness corresponding to the signals supplied to this pixel.

The transistors within the pixel circuit, however, are not ideal electrical components completely blocking leak current flows between terminals thereof, and floating state is established in the standby state where the first and second pixel power supplies are applied. Therefore, abnormal current is applied to the organic light emitting diode in the standby state, and it may cause problems of displaying images in an undesired shape or abnormally lighting the pixels such as blinking.

### SUMMARY OF THE INVENTION

It is, therefore, an object of the present invention to provide an improved organic light emitting display device and an improved driving method thereof to provide better quality of images displayed on the displays.

It is another object of the present invention to provide an organic light emitting display device and a driving method thereof capable of preventing malfunction due to an overload of a scan driver and an abnormal lighting phenomenon of pixels.

In order to accomplish the above object, according to the first aspect of the present invention, there is provided a driving method of an organic light emitting display device contemplating: supplying scan signals generated by scan driving power supplies and external scan driving control signals to a pixel unit; supplying data signals generated by data driving power supplies, data, and data driving control signals to the pixel unit; and emitting lights by pixels provided in the pixel unit, by supplying the pixel unit with pixel power supplies, the generated scan signals and the generated data signals.

Preferably, the scan driving control signals include start pulses, clock signals and output enable signals, and the output enable signals are supplied after the start pulses and the clock signals. The time point of supplying the output enable signals is set one or more frames after the time point of supplying the start pulses and the clock signals is elapsed. The scan driving power supplies are supplied prior to the scan driving control signals. Valid data signals are generated corresponding to the data and the data driving control signals supplied after the generation of the scan signals. The valid data signals are set to data signals corresponding to black gray scale before the pixel power supplies are supplied.

According to the second aspect of the present invention, there is provided an organic light emitting display device employing: a pixel unit including a plurality of pixels formed in a region partitioned by scan lines and data lines; a scan driver supplying scan signals to the scan lines; a data driver supplying data signals to the data lines; a timing controller supplying scan driving control signals and data driving control signals to the scan driver and the data driver, respectively; and a power supplier supplying driving power supplies to the pixel unit, the scan driver, the data driver and the timing controller, and the power supplier being formed to supply the pixel power supplies to the pixel unit after supplying the driving power supplies to the scan driver, the data driver and the timing controller.

Preferably, the scan driver is driven by scan driving power supplies from the power supplier and scan driving control signals from the timing controller to generate the scan signals, and the data driver is driven by data driving power supplies from the power supplier and data driving control signals from the timing controller to generate the data signals. The power supplier supplies the pixel power supplies after the generation of the scan signals and the data signals starts. The scan driving control signals include start pulses, clock signals and output enable signals of the scan driver. The scan driver includes a shift register unit sequentially generating sampling pulses corresponding to the start pulses and clock signals, and a signal generator sequentially generating scan signals corresponding to the sampling pulses, the start pulses and the output enable signals. The timing controller supplies the output enable signals to the scan driver one or more frames after the starting time point of supplying the start pulses and the clock signals to the scan driver is elapsed.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is an illustrate of an organic light emitting display device constructed according to one embodiment of the present invention;

FIG. 2 shows one example of internal circuits of a scan driver as shown in FIG. 1;

FIG. 3A shows a sample group of waveforms a driving method of a scan driver as shown in FIG.2;

FIG.3B shows a sample group of waveforms a driving method of a scan driver constructed according to another embodiment of the present invention;

FIG. 4 shows one example of internal circuits of a pixel as shown in FIG. 1;

FIG. 5 is a group of waveforms showing driving signals of a pixel as shown in FIG. 4; and

FIG. 6 is a group of waveforms showing a driving method of an organic light emitting display device as shown in FIG. 1.

### DETAILED DESCRIPTION OF THE INVENTION

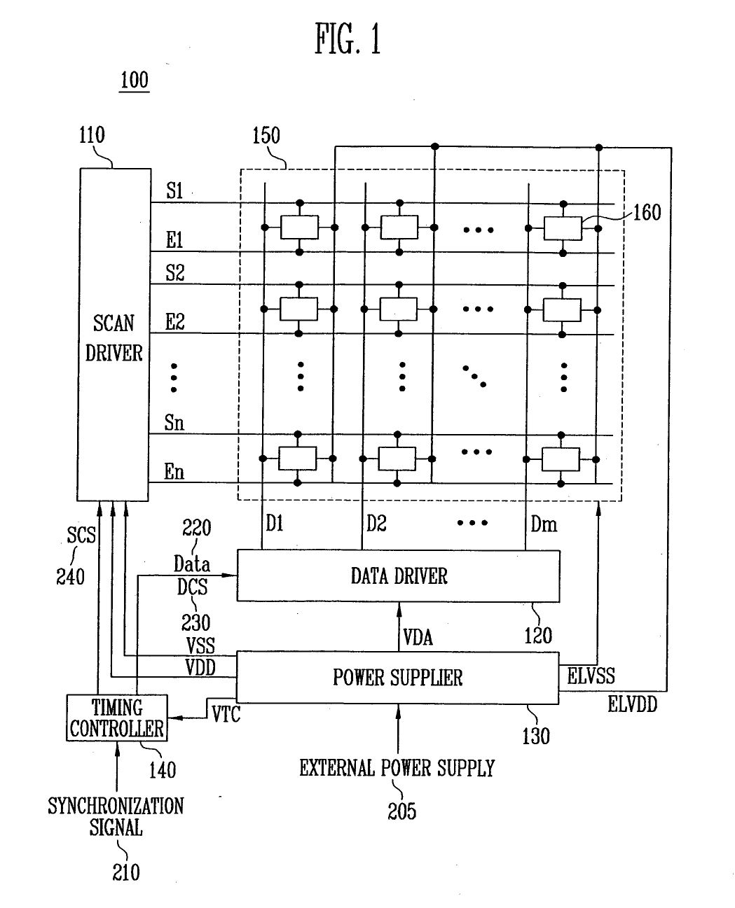

Hereinafter, preferable embodiments according to the present invention, which can be easily carried out by those skilled in the art, will be described with reference to the accompanying FIG. 1 to FIG. 6.

FIG. 1 is an illustrate of an organic light emitting display device constructed according to one embodiment of the present invention.

Referring to FIG. 1, an organic light emitting display device 100 according to an embodiment of the present invention includes a scan driver 110, a data driver 120, a timing controller 140, a pixel unit 150 and a power supplier 130.

Scan driver 110 generates scan signals and light emitting control signals corresponding to scan driving control signals SCS 240 supplied from the timing controller 140. The scan signals and light emitting control signals generated by scan driver 110 are sequentially supplied to scan lines S1 to Sn and light emitting control lines E1 to En, respectively. Scan driving control signals SCS 240 include start pulses SP, clock signals CLK and output enable signals OE.

Data driver 120 generates data signals corresponding to data Data 220 and driving control signals DCS 230 supplied from timing controller 140. The data signals generated from data driver 120 are supplied to data lines D1 to Dm and are synchronized with the scan signals supplied to scan lines S1-Sn.

Timing controller 140 generates scan driving control signals SCS and data driving control signals DCS 230 corresponding to external synchronization signals 210 supplied from the exterior of the display. Scan driving control signals SCS 240 and data driving control signals DCS 230 generated from timing controller 140 are supplied to scan driver 110 and data driver 120, respectively. Also, timing controller 140 receives data Data 220 supplied from the exterior of timing controller 140. and transfers data Data 220 corresponding to synchronization signals to data driver 120. And the data driver 120 generates data signals based on data Data 220.

In the present invention, however, the time points of supplying all the scan driving control signals SCS supplied from timing controller 140 to scan driver 110 are not set to be identical. For example, when start pulses SP, clock signals CLK and output enable signals OE are supplied from timing controller 140 to scan driver 110, timing controller 140 may be set to start supplying start pulses SP and clock signals CLK followed by one frame as compared to the time point of supplying output enable signals OE Note that timing controller 140 may be set to start supplying start pulses SP and clock signals CLK followed by one or more frames as compared to the time point of supplying output enable signals OE in the present invention.

A pixel unit 150 includes a plurality of pixels 160 formed in a region partitioned by scan lines S1 to Sn, light emitting control lines E1 to En, and data lines D1 to Dm. Pixel unit 150 displays images corresponding to the scan signals and the light emitting control signals supplied from the scan driver 110, and data signals supplied from data driver 120.

Power supplier 130 generates driving power supplies for scan driver 110, data driver 120, timing controller 140, and pixel unit 150 by using external power supplies 205 supplied from an external power supply apparatus (not shown in drawings), and supplies them to scan driver 110, data driver 120, timing controller 140, and pixel unit 150, respectively. For example, power supplier 130 generates first and second scan driving power supplies VDD and VSS, and then supply them to scan driver 110; and power supplier 130 may generate first and second pixel power supplies ELVDD and ELVSS, and then supply them to pixel unit 150. Also, power supplier 130 may generate data driving power supplies VDA and timing driving power supplies VTC and then supply them to data driver 120 and timing controller 140, respectively.

In the present invention, power supplier 130 is equipped to supply first and second scan driving power supplies VDD and VSS to scan driver 110 and then to supply first and second pixel power supplies ELVDD and ELVSS to pixel unit 150. In particular, power supplier 130 is controlled to finally apply the first and second pixel power supplies ELVDD and ELVSS among power supplies and signals supplied to scan driver 110, data driver 120, timing controller 140, and pixel unit 150. The more detailed explanation thereof will be described later.

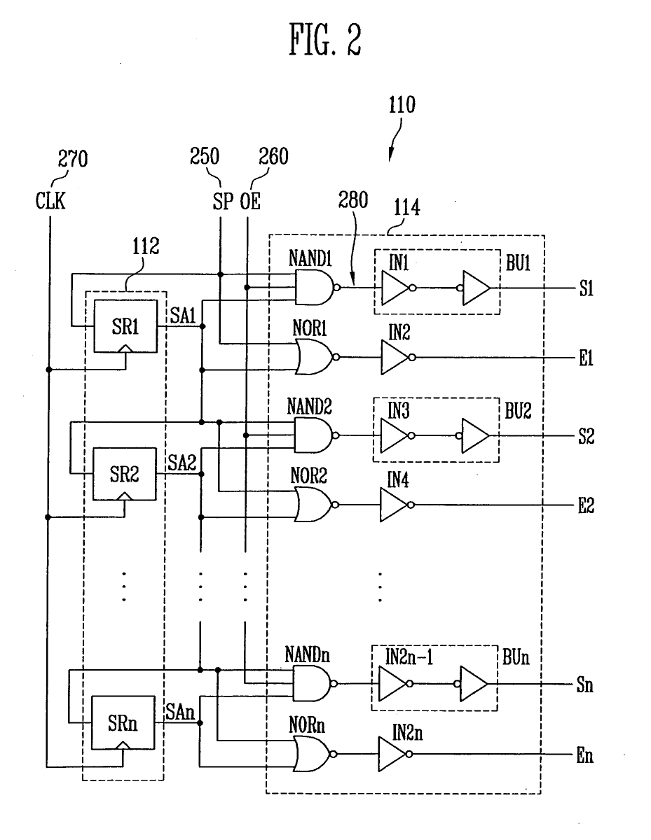

FIG. 2 shows one example of internal circuits of a scan driver as shown in FIG. 1.

Referring to FIG. 2, scan driver 110 includes a shift register unit 112 and a signal generator 114.

Shift register unit 112 generates sampling pulses SA (i.e. SA1, SA2, . . . , SAn) while sequentially shifting start pulses SP 250 supplied from timing controller 140 corresponding to clock signals CLK 270.

Shift register unit 112 includes a plurality of shift registers SR1 to SRn cascadingly electrically connected to an input stage of start pulses SP 250. Shift register SR1 generates first sampling pulses SA1 by using start pulses SP 250 and clock signals CLK 270, shift register SR2 generates second sampling pulses SA2 by using first sampling pulses SA1 and clock signals CLK 270, and by parity of reasoning, a shift register other than SR1 generates sampling pulses by using sampling pulses generated at the preceding stage and clock signals CLK 270. Therefore, start pulse SP 250 and sampling pulses are supplied to signal generator 114 in a predetermined subsequence.

For example, as shown in FIG. 2, shift register unit 112 includes a number of n shift registers SR (n represents natural number), and each shift register may be constituted by D-Flip-Flop (DF).

Herein, odd numbered shift registers SR1, SR3, . . . are driven at the rising edge of the clock signals CLK, and even numbered shift registers SR2, SR4, . . . are driven at the falling edges of the clock signals. In other words, shift register unit 112 is alternately disposed with the shift registers driven at the rising edges of clock signals CLK 270 and shift registers SR 112 driven at the falling edges thereof.

Shift registers SR1 to SRn are driven when clock signals CLK 270 and start pulses SP 250 (or sampling pulses of preceding stage) are supplied from the exterior of scan driver 110.

Signal generator 114 generates scan signals and light emitting control signals corresponding to sampling pulses SA supplied from shift register unit 112 and start pulses SP 250 and output enable signals OE 260 supplied from timing controller 140.

Signal generator 114 includes a plurality of logic gates. In fact, the signal generator 114 includes a number of n NAND gates installed with respect of scan lines S1 to Sn, and a number of n NOR gates NOR installed with respect of light emitting control lines E1 to En.

The “k” here represents natural number equal to or smaller than n, in other words, k≦n. The k numbered NAND gate NANDk is driven by means of output enable signal OE 260, sampling pulses SAk of k numbered shift register SRk, and sampling pulses SA(k−1) of k−1 numbered shift register SR(k−1). Herein, the output of the k numbered NAND gate NANDk is supplied to the k numbered scan line Sk via at least one inverter IN and a buffer BU. The buffer BU also functions as a NOT gate. For gate NAND1, the output of gate NAND1 may be presented by a logical symbol: O̅E̅ [symbol] S̅P̅ [symbol] S̅R̅1̅, and in parity of reasoning, the output of gate NANDk may be presented by logical symbol: O̅E̅ [symbol] S̅R̅(̅k̅−̅1̅)̅ [symbol] S̅R̅k̅, where SR1 is the output signals of first shift register SR1, SR(k−1) is the output signals of number (k−1) shift register SR(k−1), and SRk is the output signals of number k shift register Srk.

The k numbered NOR gate NORk is driven by means of the sampling pulses SAk−1 numbered of the k−1 shift register and the sampling pulses SAk of the k numbered shift register. Herein, the output of the k numbered NOR gate NORk is supplied to the k numbered light emitting control line Ek via at least one inverter IN. For gate NORk, output of gate NORk may be presented by logical symbol: S̅R̅(̅k̅−̅1̅)̅ [symbol] S̅R̅k̅. The reference number 280 presents the output signal from gate NAND1.

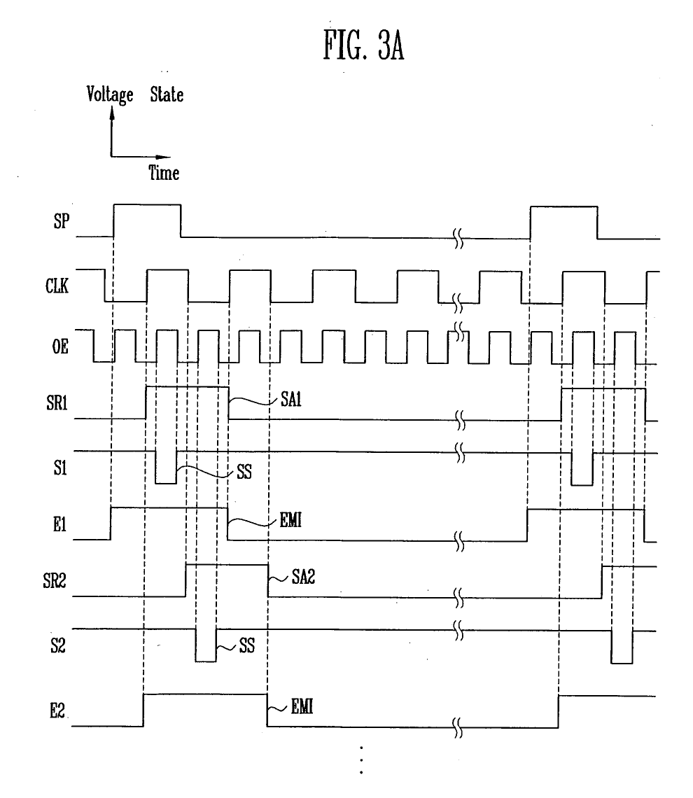

FIG. 3A shows a sample group of waveforms a driving method of a scan driver as shown in FIG. 2. Waveform SP shows the voltage states of start pulse signal SP 250 varying in time domain, waveform CLK shows the voltage states of clock signal CLK 270 varying in time domain, waveform OE shows the voltage states of output enable signals OE 260 varying in time domain, waveform SR1 shows the voltage states of the output signals of first shift register SR1 varying in time domain, waveform S1 shows the voltage states of the signals in first scan line S1 varying in time domain, waveform E1 shows the voltage states of the signals in first emitting control line E1 varying in time domain, waveform SR2 shows the voltage states of the output signals of second shift register SR2 varying in time domain, waveform S2 shows the voltage states of the signals in second scan line S2 varying in time domain, and waveform E2 shows the voltage states of the signals in second emitting control line E2 varying in time domain. FIG. 3 samples the output signals of first two sets of shift registers, the signals in second scan lines and emitting control lines, and output signals of other shift registers, signals in other scan lines and emitting control lines follow the same scenario as shown in FIG. 3A and will not repeated in the specification.

Referring to FIG. 3A, start pulses SP, clock signals CLK 270 and output enable signals OE 260 are first supplied from timing controller 140 to scan driver 110. Herein, output enable signals OE 260 have a half (½) length of time period of clock signals CLK 270, and the high voltage state of the output enable signals OE 260 are set to overlap with the high voltage state of clock signals CLK 270. Output enable signals OE 260 are supplied to control the width of scan signals SS (i.e. SS1, SS2, . . . ). In fact, scan signals SS are formed to have the same width with the high voltage of the output enable signals OE.

Scan driver 110 supplied with start pulse SP 250, clock signal CLK 270 and output enable signal OE 260 sequentially generates the scan signals SS and the light emitting signals EMI (i.e. EMI1, EMI2, . . . ), and then outputs them to scan lines S1 to Sn and light emitting control lines E1 to En, respectively.

More specifically, when the start pulses SP and the clock signals CLK are supplied to the shift register unit 112 and the start pulses SP and the output enable signals OE are supplied to the signal generator 114, scan driver 110 starts to be driven. First and second scan driving power supplies VDD and VSS are supplied to drive scan driver 110 by power supplier 130 before the start pulses SP, the clock signals CLK, and the output enable signals OE are supplied to drive scan driver 110.

When start pulses SP 250 are supplied to first shift register SR1, first NAND gate NAND1, and first NOR gate NOR1, first shift register SR1, as a D-Flip-Flop register, takes the state of the input signal (i.e. SP) at the first rising edge of clock signals CLK 270, and therefore, output signals of first shift register SR1 changes to high voltage state at the rising edge of clock signals CLK 270 and first sampling pulse SA1 is obtained. First sampling pulse SA1 generated at first shift register SR1 is supplied to first NAND gate NAND1, first NOR gate NOR1, second shift register SR2, and second NAND gate NAND2.

Gate NAND1 supplied with the start pulse SP, output enable signal OE, and first sampling pulse SA1 outputs low voltage when all the three signals supplied have high voltage. And, gate NAND1 outputs high voltage in any other situation. In fact, gate NAND1 has low voltage state in the time period where output enable signals OE 260, first sampling pulse SA1 and start pulse SP are all in high voltage states. The low voltage output from gate NAND1 is supplied to first scan lines S1 via first inverter IN1 and the first buffer BU1. The low voltage supplied to first scan line S1 is supplied to the pixels as scan signal SS. Mathematically, signals on first scan line S1 may be presented by logical symbol: O̅E̅ [symbol] S̅P̅ [symbol] S̅R̅1̅, and signals on a general scan line Sk other than S1 may be presented by logical symbol: O̅E̅ [symbol] S̅R̅(̅k̅−̅1̅)̅ [symbol] S̅R̅k̅.

Gate NOR1 supplied with start pulse SP and first sampling pulse SA1 outputs a high voltage when all the two signals supplied have low voltages. And, gate NOR1 outputs low voltage in any other situation. In fact, gate NOR1 outputs low voltage when at least one of the start pulse SP and the first sampling pulse SA1 have high voltage. The low voltage output of gate NOR1 is inverted to high voltage by second inverter IN2 and then is supplied to a first light emitting control line E1. The high voltage supplied to the first light emitting control line E1 is supplied to the pixels as light emitting control signals EM1. Mathematically, signals on first light emitting control line E1 maybe presented by logical symbol: SP [symbol] SR1, and signals in a general light emitting control line Ek other than E1 may be presented by logical symbol: SR(k−1) [symbol] SRk.

Scan driver 110 sequentially supplies scan signals SS to first scan line S1 to number n scan line Sn, and supplies light emitting control signals EM1 to first light emitting control line E1 to number n light emitting control line En, while repeating the above-presented method.

Additionally, the high voltage level of the signals on scan lines and the light emitting control signals EM1 are set based on a voltage level of first scan driving power supplies VDD of scan driver 110, and the low level voltages thereof are set based on a voltage level of second scan driving power supply VSS of the scan driver 110. In other words, first and second scan driving power supplies VDD and VSS are used as reference voltages of scan signals SS and light emitting control signals EM1. Therefore, first and second driving power supplies VDD and VSS are supplied from the time point followed by the time point of supplying start pulses SP and clock signals CLK in order that the signal supplies from scan driver 110 may be stable.

During driving scan driver 110, however, if start pulses SP, clock signals CLK, and output enable signals OE are simultaneously supplied at the time point of driving scan driver 110, all the logic circuits included in signal generator 114 operate at the same time so that scan driver 110 may instantly be overloaded.

FIG. 3B shows a sample group of waveforms a driving method of a scan driver constructed according to another embodiment of the present invention. The waveforms as shown in FIG. 3B have same meanings as those of FIG. 3A.

In order to prevent this overload of scan driver 110, the time point of supplying start pulses SP 250 and clock signals CLK 270 starts one frame ahead compared to the time point of supplying output enable signals OE 260 in the present invention as shown in FIG. 3B. Accordingly, after shift register unit 112 of scan driver 110 sequentially generates sampling pulses SA and NOR gates of signal generator 114 operate according to the generated sampling pulses SA during one frame 1F, shift register unit 112 and signal generator 114 operate together in next frame. In this case, since only the NAND gates of signal generator 114 operate at the time point that the output enable signals OE are started to be supplied, the simultaneous operation of all the logic circuits in the signal generator 114 is prevented. Thereby, the malfunction due to the overload of scan driver 110 may be prevented. One frame here refers to the time period from one positive start pulse signal to next positive start pulse signal.

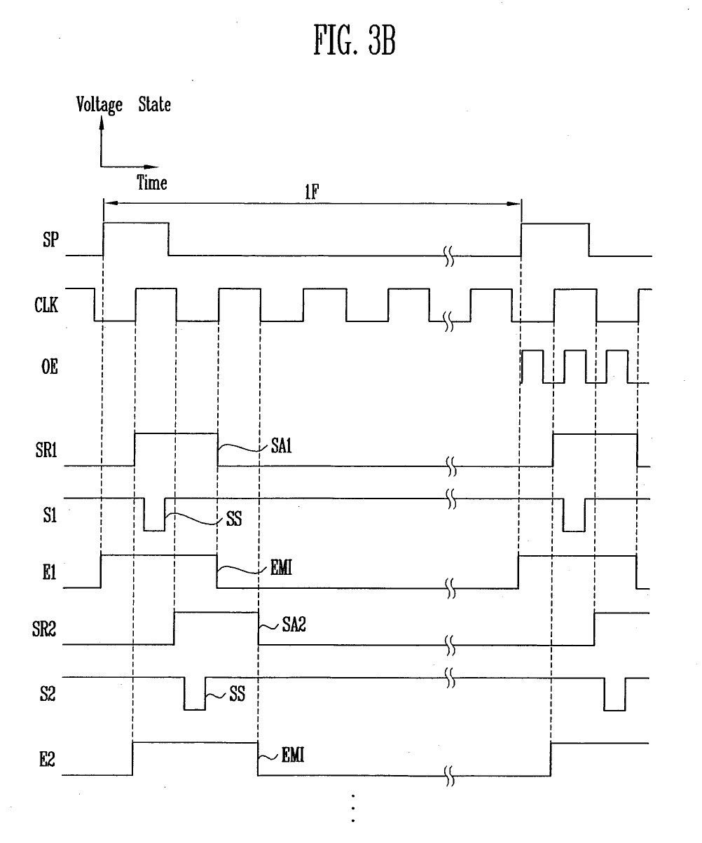

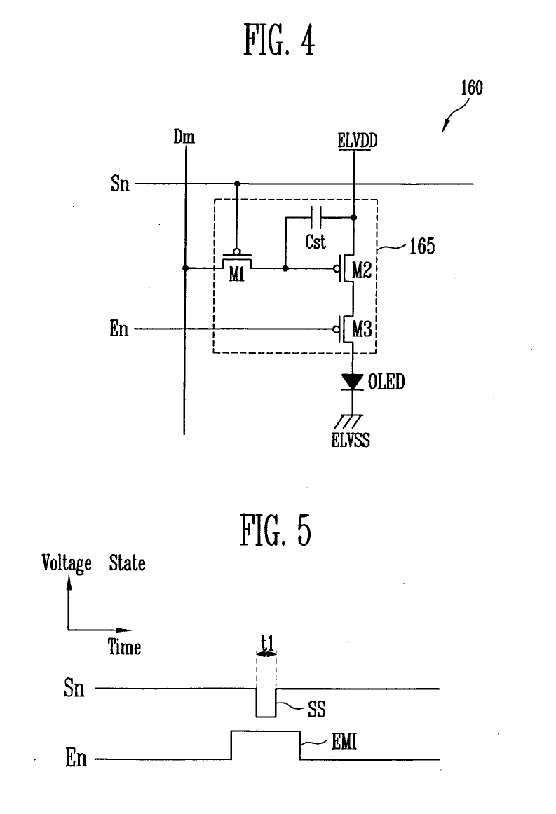

FIG. 4 shows one example of internal circuits of a pixel as shown in FIG. 1. For convenience, FIG. 4 will show a pixel electrically connected to number n scan line Sn, an number n light emitting control line En, and number m data line Dm. And, FIG. 5 is a group of waveforms showing driving signals of a pixel as shown in FIG. 4.

Referring to FIGS. 4 and 5, pixel 160 includes a pixel circuit 165 coupled to scan line Sn, light emitting control line En, and data line Dm to control current supplied to an organic light emitting diode OLED, and organic light emitting diode OLED electrically connected to pixel circuit 165 to emit lights corresponding to the current supplied from pixel circuit 165.

Pixel circuit 165 includes first to third transistors M1 to M3, and a storage capacitor Cst.

The gate terminal of first transistor M1 is connected to scan line Sn. And, the first terminal of first transistor M1 is electrically connected to data line Dm, and the second terminal is electrically connected to one electrode of storage capacitor Cst. Herein, the first and second terminals are different from each other, for example, if the first terminal is a source terminal, the second terminal is a drain terminal. When scan signal SS of low voltage level is supplied to scan line Sn in a t1 time period as shown in FIG. 5, first transistor M1 is turned on to supply the data signal supplied from data line Dm to storage capacitor Cst.

One electrode of the storage capacitor Cst is electrically connected to the second terminal of the first transistor M1, and the other electrode is coupled to first pixel power supply ELVDD. When the data signal supplied from data line Dm is supplied from first transistor M1, storage capacitor Cst is charged by a voltage corresponding the data signal and maintain the voltage during one frame.

The gate terminal of second transistor M2 is electrically connected to one electrode of storage capacitor Cst. And, first terminal of the second transistor M2 is electrically connected to first pixel power supply ELVDD, and the second terminal thereof is electrically connected to the first terminal of third transistor M3. Such second transistor M2 supplies the voltage charged in storage capacitor Cst (i.e., voltage corresponding to the data signal) from first pixel power supply ELVDD to the first terminal of third transistor M3.

The gate terminal of third transistor M3 is coupled to light emitting control line En. And, the first terminal of third transistor M3 is electrically connected to the second terminal of second transistor M2, and the second terminal is electrically connected to an anode electrode of organic light emitting diode OLED. When the light emitting control signal supplied to the gate electrode of third transistor M3 is a low level, third transistor M3 is turned on to supply the current supplied from second transistor M2 to organic light emitting diode OLED.

In other words, third transistor M3 blocks the supply of current from second transistor M2 to organic light emitting diode OLED when light emitting control signal EM 1 is in high voltage state as shown in FIG. 5, and supplies the current supplied from second transistor M2 to organic light emitting diode OLED via transistor M3 from the time point when the voltage level of the light emitting control signal EM1 falls to a low level.

The anode electrode of organic light emitting diode OLED is electrically connected to the second terminal of third transistor M3, and a cathode electrode of organic light emitting diode OLED is electrically connected to a second pixel power supply ELVSS. Therefore, organic light emitting diode OLED emits lights having a brightness corresponding to the electrical current amount supplied from pixel circuit 165.

The transistors M1, M2 and M3 included in pixel circuit 165, however, are not ideal electrical components completely blocking leak current flow between first and second terminals of the transistor. Therefore, a floating state is established, when scan signal SS, light emitting control signal EM1 and/or data signal are not supplied in a standby state where first and second pixel power supplies ELVDD and ELVSS are applied. In this case, pixel circuit 165 may supply abnormal current to organic light emitting diode OLED so that organic light emitting diode OLED may emit lights and generate images in an undesired shape or an abnormally blinking is generated on a display.

In order to prevent the problems presented above, in the present invention, the time point of starting supplying first and second pixel power supplies ELVDD and ELVSS is set after the time points of supplying first and second power supplies VDD and VSS, start pulses SP, clock signals CLK, and output enable signals OE of scan driver 110, that is, after the time point when scan driver 110 normally operates. Also, data driving control signals DCS 230 and data Data 220 are applied from timing controller 140 to data driver 120 so that the data signals are generated from data driver 120, before first and second pixel power supplies ELVDD and ELVSS are applied to pixel 160.

As described above, the time point of supplying the first and second pixel power supplies ELVDD and ELVSS is set to be after the time point of supplying other power supplies and signals, so that the leak current does not flow through the organic light emitting diode OLED while first and second pixel power supplies ELVDD and ELVSS are not applied. It is, therefore, possible to prevent abnormal lightings of pixel 160.

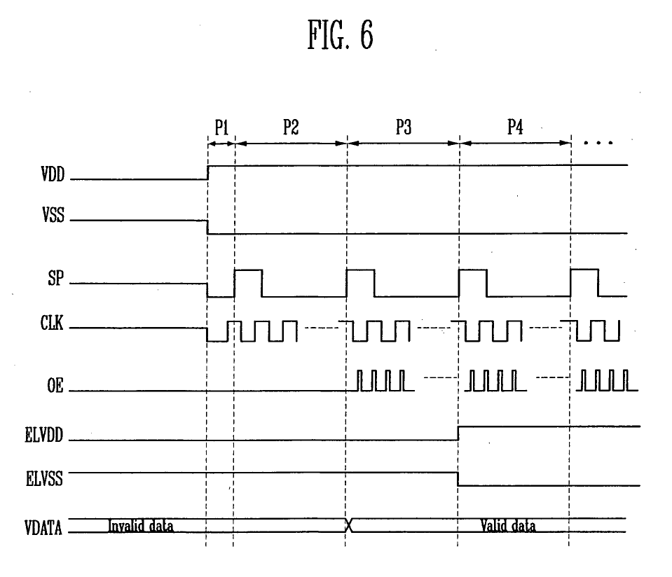

FIG. 6 is a group of waveforms showing a driving method of an organic light emitting display device as shown in FIG. 1. Waveform SP shows the voltage states of start pulse signal SP 250 varying in time domain, waveform CLK shows the voltage states of clock signal CLK 270 varying in time domain, waveform OE shows the voltage states of output enable signals OE 260 varying in time domain, waveform VDD shows the voltage states of first scan driving power supplies VDD varying in time domain, waveform VSS shows the voltage states of second scan driving power supplies VSS varying in time domain, waveform ELVDD shows the voltage states of first pixel power supplies ELVDD varying in time domain, waveform ELVSS shows the voltage states of first and second pixel power supplies ELVSS varying in time domain, and waveform VDATA shows the voltage states of data signal in data lines.

Referring to FIG. 6, from a time period P1, first and second scan driving power supplies VDD and VSS are firstly supplied to scan driver 110 by power supplier 130.

Thereafter, from a time period P2, start pulses SP and clock signals CLK are applied from timing controller 140 to scan driver 110, and thereby, sampling pulses SA (as shown in FIG. 3B) are sequentially generated from shift register 112. P2 period can be set to be one frame period or more in order that all the respective shift registers SR included in shift register unit 112 generate sampling pulses SA. However, output enable signals OE are not supplied during time periods P1 and P2 so that the preceding overload of scan driver 110 as described above is prevented.

Thereafter, from a time period P3, output enable signals OE are supplied from timing controller 140 to scan driver 110. Thereby, signal generator 114 is driven so that scan signals SS and light emitting control signals EM1 are sequentially generated. And, from time period P3, data signals VDATA are supplied as valid data. First and second pixel power supplies ELVDD and ELVSS, however, are still not supplied during the period so that pixel unit 150 does not display images, and at this time period supplied data signals VDATA may be displayed in a black gray scale on the display. The black scale refers to the bottom gray scale. In other words, the black scale refers to the darkest level of color on the gray scale.

Thereafter, from a time period P4, first and second pixel power supplies ELVDD and ELVSS are supplied from power supplier 130 to pixel unit 150 as well as the data signals VDATA for actually displaying images are supplied to pixel unit 150. Thereby, in pixel unit 150 displays images corresponding to data signals VDATA.

As described above, the organic light emitting display device of the present invention may prevent malfunction due to the overload of scan driver 110 and the abnormal lighting phenomenon of pixels 160.

More specifically, with the organic light emitting display device and the driving method thereof according to the present invention, the start pulses and the clock signals of the scan driver are supplied one or more frames before compared to the time point of supplying the output enable signals thereof, and the malfunction due to the overload of the scan driver is prevented.

More specifically, the supply of the first and second pixel power supplies starts after the time point when the scan signals and the light emitting control signals from the scan driver and the data signals from the data driver are supplied to the pixel unit, and the abnormal lighting phenomena of the pixels are prevented.

Although a few embodiments of the present invention have been shown and described, it would be appreciated by those skilled in the art that changes might be made in this embodiment without departing from the principles and spirit of the invention, the scope of which is defined in the claims and their equivalents.

What is claimed is:

1. A driving method of an organic light emitting display device, comprising:
supplying scan signals generated by scan driving power supplies and scan driving control signals to a pixel unit;
supplying data signals generated by external data driving power supplies, data, and data driving control signals to the pixel unit; and
emitting lights by pixels provided in the pixel unit, by supplying the pixel unit with pixel power supplies, the generated scan signals and the generated data signals.

2. The driving method of the organic light emitting display device as claimed in claim 1, wherein the scan driving control signals include start pulses, clock signals and output enable signals, and the output enable signals are supplied after the start pulses and the clock signals are supplied.

3. The driving method of the organic light emitting display device as claimed in claim 2, wherein the time point of supplying the output enable signals is set after one or more frames after the time point of supplying the start pulses and the clock signals is elapsed.

4. The driving method of the organic light emitting display device as claimed in claim 1, wherein scan driving power supplies are supplied prior to the scan driving control signals.

5. The driving method of the organic light emitting display device as claimed in claim 1, wherein valid data signals are generated corresponding to the data and the data driving control signal supplied after the generation of the scan signals.

6. The driving method of the organic light emitting display device as claimed in claim 5, wherein the valid data signals are set to data signals corresponding to black gray scale until the pixel power supplies are supplied.

7. An organic light emitting display device comprising:
a pixel unit including a plurality of pixels formed in a region partitioned by scan lines and data lines;
a scan driver supplying scan signals to the scan lines;
a data driver supplying data signals to the data lines;
a timing controller supplying scan driving control signals and data driving control signals to the scan driver and the data driver, respectively;
a power supplier supplying driving power supplies to the pixel unit, the scan driver, the data driver and the timing controller; and
the power supplier being formed to supply the pixel power supplies to the pixel unit after supplying the driving power supplies to the scan driver, the data driver and the timing controller.

8. The organic light emitting display device as claimed in claim 7, wherein the scan driver is driven by means of scan driving power supplies from the power supplier and scan driving control signals from the timing controller to generate the scan signals, and the data driver is driven by means of data driving power supplies from the power supplier and data driving control signals from the timing controller to generate the data signals.

9. The organic light emitting display device as claimed in claim 8, wherein the power supplier supplies the pixel power supplies after the generation of the scan signals and the data signals starts.

10. The organic light emitting display device as claimed in claim 7, wherein the scan driving control signals include start pulses, clock signals and output enable signals of the scan driver.

11. The organic light emitting display device as claimed in claim 10, wherein the scan driver comprises:
a shift register unit sequentially generating sampling pulses corresponding to the start pulses and clock signals; and
a signal generator sequentially generating scan signals corresponding to the sampling pulses, the start pulses and the output enable signals.

12. The organic light emitting display device as claimed in claim 10, the timing controller supplies the output enable signals to the scan driver one or more frame after the time point that the supply of the start pulses and the clock signals to the scan driver starts.

13. A driving method of an organic light emitting display device, comprising:
supplying first and second scan driving power supplies generated by a power supplier to a scan driver from a first predetermined time period, and said first predetermined time period immediately followed by a second predetermined time period;
supplying start pulses and clock signals generated by a timing controller to the scan driver from said second predetermined time period, and said second predetermined time period immediately followed by a third predetermined time period;
supplying output enable signals to the scan driver from a third predetermined time period, and said third predetermined time period immediately followed by a fourth predetermined time period;
supplying first and second pixel power supplies to a pixel unit from said fourth predetermined time period;
supplying scan signals generated based on the scan driving power supplies and scan driving control signals, which comprises start pulses, clock signals and output enable signals, to the pixel unit;
supplying data signals generated by data, data driving control signals and data driving power supplies to the pixel unit;
supplying light emitting signals generated by sampling pulses provided by shift register unit of the scan driver; and
emitting lights by pixel circuits of pixels provided in the pixel unit, by supplying the pixel unit with pixel power supplies, the scan signals, the data signals and the light emitting signals.

14. The driving method of the organic light emitting display device of claim 13, further comprising generating sampling pulses by shift register unit of the scan driver in said second predetermined time period.

15. A driving method of an organic light emitting display device, comprising:
supplying scan signals generated based on the scan driving power supplies and scan driving control signals to a pixel unit, and said scan driving control signals being provided asynchronously;
supplying data signals generated by external data signal data, driving control signals and data driving power supplies to the pixel unit;
supplying light emitting signals generated by sampling pulses provided by shift register unit of the scan driver; and
emitting lights by pixel circuits of pixels provided in the pixel unit, by supplying the pixel unit with pixel power supplies, the scan signals, the data signals and the light emitting signals.

16. The driving method of the organic light emitting display device of claim 15, with said scan driving control signal comprising start pulses, clock signals and output enable signals.

17. The driving method of the organic light emitting display device of claim 16, further comprising:
supplying a first and second scan driving power supplies generated by a power supplier to a scan driver from a first predetermined time period, and said first predetermined time period immediately followed by a second predetermined time period;
supplying start pulses and clock signals generated by a timing controller to the scan driver from said second predetermined time period, and said second predetermined time period immediately followed by a third predetermined time period;
supplying output enable signals to the scan driver from a third predetermined time period, and said third predetermined time period immediately followed by a fourth predetermined time period; and
supplying first and second pixel power supplies to the pixel unit from said fourth predetermined time period.

18. The driving method of the organic light emitting display device of claim 17, further comprising:
supplying start pulses and clock signals generated by a timing controller to the scan driver from said second predetermined time period, and said second predetermined time period immediately followed by a third predetermined time period; and
supplying output enable signals to the scan driver from a third predetermined time period, and said third predetermined time period immediately followed by a fourth predetermined time period.

19. An organic light emitting display device; comprising:
a pixel unit including a plurality of pixels formed in a region partitioned by scan lines and data lines;
a scan driver supplying scan signals to the scan lines;
a data driver supplying data signals to the data lines;
a timing controller supplying scan driving control signals and data driving control signals to the scan driver and the data driver, respectively;
a power supplier supplying driving power supplies to the pixel unit, the scan driver, the data driver and the timing controller;
the power supplier being formed to supply the pixel power supplies to the pixel unit after supplying the driving power supplies to the scan driver, the data driver and the timing controller;
said timing controller supplying output enable signals to the scan driver one or more frames after the time point of starting supplying start pulses and clock signals to the scan driver.

20. The organic light emitting display device of claim 19, with the power supplier supplying the pixel power supplies after the generation of scan signals and data signals starts.
